(19) United States
(12) Patent Application Publication
(10) Pub. No.: US 2025/0167493 A1
(43) Pub. Date: May 22, 2025

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shuhei TERADA, Osaka (JP)

(21) Appl. No.: 18/842,393

(22) PCT Filed: Feb. 10, 2023
(86) PCT No.: PCT/JP2023/004593

§ 371 Date: Aug. 29, 2024

(30) Foreign Application Priority Data
Mar. 2, 2022 (JP) 2022-031430

(51) Int. Cl. H01R 13/6476; H01R 9/05; H01R 24/44

(52) U.S. Cl. CPC H01R 13/6476; H01R 9/0518; H01R 24/44

(57) ABSTRACT

A first connector includes a first inner conductor, a first dielectric surrounding the first inner conductor and a first outer conductor surrounding the first dielectric. A second connector includes a second inner conductor, a second dielectric surrounding the second inner conductor and a second outer conductor to be connected to the first outer conductor while surrounding the second dielectric. An interval in a radial direction between the first inner conductor and the first outer conductor is narrower than an interval in the radial direction between the second inner conductor and the second outer conductor. The first dielectric is formed with a first air chamber for impedance matching shaped by recessing a peripheral surface of the first dielectric. The second dielectric is formed with a second air chamber for impedance matching shaped by recessing a peripheral surface of the second dielectric.

### TECHNICAL FIELD

The present disclosure relates to a shield connector.

### BACKGROUND

Patent Document 1 discloses a coaxial connector structured to surround inner conductor terminals by dielectrics and surround the dielectrics by outer conductor terminals. In a connected part of the female outer conductor terminal and the male outer conductor terminal, the female outer conductor terminal is arranged to surround the male outer conductor terminal.

### PRIOR ART DOCUMENT

### Patent Document

Patent Document 1: JP 2015-162375 A

### SUMMARY OF THE INVENTION

### Problems to be Solved

In the case of applying the coaxial connector of this type to a circuit for high-speed communication, impedance matching is important. However, since the inner conductor terminals, the dielectrics and the outer conductor terminals are formed with various functional parts and complicated in shape, impedance matching is difficult.

A shield connector of the present disclosure was completed on the basis of the above situation and aims to enhance impedance matching.

### Means to Solve the Problem

The present disclosure is directed to a shield connector with a first connector and a second connector to be connected to each other, the first connector including a first inner conductor, a first dielectric surrounding the first inner conductor and a first outer conductor surrounding the first dielectric, the second connector including a second inner conductor to be connected to the first inner conductor, a second dielectric surrounding the second inner conductor and a second outer conductor to be connected to the first outer conductor while surrounding the second dielectric, an interval in a radial direction between the first inner conductor and the first outer conductor being narrower than an interval in the radial direction between the second inner conductor and the second outer conductor, the first dielectric being formed with a first air chamber for impedance matching shaped by recessing a peripheral surface of the first dielectric, the second dielectric being formed with a second air chamber for impedance matching shaped by recessing a peripheral surface of the second dielectric, and a volume of the first air chamber being larger than a volume of the second air chamber.

### Effect of the Invention

According to the present disclosure, impedance matching can be enhanced.

### BRIEF DESCRIPTION OF THE DRAWINGS

FIG. 1 is a perspective view showing a state where a first connector and a second connector are separated in a shield connector of one embodiment.

FIG. 2 is a perspective view showing a disassembled state of the first connector.

FIG. 3 is a section of the first connector.

FIG. 4 is a partial enlarged section showing a retaining structure for a first inner conductor.

FIG. 5 is a partial enlarged external view showing the first inner conductor and a first dielectric in the first connector.

FIG. 6 is a perspective view showing a disassembled state of the second connector.

FIG. 7 is a section of the second connector.

FIG. 8 is a partial enlarged section showing a retaining structure for a second inner conductor.

FIG. 9 is a partial enlarged section showing a connection structure of the first and second connectors.

### DETAILED DESCRIPTION TO EXECUTE THE INVENTION

### Description of Embodiments of Present Disclosure

First, embodiments of the present disclosure are listed and described.
(1) The shield connector of the present disclosure is provided with a first connector and a second connector to be connected to each other, the first connector including a first inner conductor, a first dielectric surrounding the first inner conductor and a first outer conductor surrounding the first dielectric, the second connector including a second inner conductor to be connected to the first inner conductor, a second dielectric surrounding the second inner conductor and a second outer conductor to be connected to the first outer conductor while surrounding the second dielectric, an interval in a radial direction between the first inner conductor and the first outer conductor being narrower than an interval in the radial direction between the second inner conductor and the second outer conductor, the first dielectric being formed with a first air chamber for impedance matching shaped by recessing a peripheral surface of the first dielectric, the second dielectric being formed with a second air chamber for impedance matching shaped by recessing a peripheral surface of the second dielectric, and a volume of the first air chamber being larger than a volume of the second air chamber.

Characteristic impedances in the first and second connectors decrease as the intervals in the radial direction between the inner conductors and the outer conductors become narrower. The characteristic impedance increases as the volume of the air chamber formed in the dielectric (between the inner conductor and the outer conductor) increases. In the shield connector of the present disclosure, the volume of the first air chamber formed between the first inner conductor and the first outer conductor is set to be larger than that of the second air chamber formed between the second inner conductor and the second outer conductor in view of the interval in the radial direction between the first inner conductor and the first outer conductor narrower than the interval in the radial direction between the second inner conductor and the second outer conductor. By this configuration, impedance matching between the first and second connectors can be enhanced.
(2) Preferably, the first air chamber is open in an inner peripheral surface of the first dielectric, the first inner conductor is inserted into the first dielectric from behind, the first inner conductor is formed with a first locking portion, and the first inner conductor is retained by locking the first locking portion to a first retaining portion on an opening edge part of the first air chamber. According to this configuration, since the first air chamber has both a function of enhancing impedance matching and a function of retaining the first inner conductor, the shape of the first dielectric can be simplified.
(3) Preferably, in (2), the first locking portion is resiliently deformed in the radial direction in the process of inserting the first inner conductor into the first dielectric, and the first locking portion resiliently returns and is locked to the first retaining portion when the first inner conductor is inserted to a proper position with respect to the first dielectric. According to this configuration, insertion resistance can be reduced in the process of inserting the first inner conductor into the first dielectric. When the first inner conductor is inserted to the proper position, a click feeling due to a resilient returning movement of the first locking portion can be sensed.
(4) Preferably, in (2) or (3), the first locking portion includes a first tapered portion extending obliquely rearward from an outer peripheral surface of the first inner conductor, and a first straight portion cantilevered parallel to an axis of the first inner conductor from a rear end of the first tapered surface. According to this configuration, since a radial projection dimension of the first locking portion is suppressed to be small, an outer diameter variation in the first inner conductor is reduced and impedance matching is enhanced.
(5) Preferably, in (4), the first inner conductor is retained by a rear end surface of the first straight portion coming into surface contact with the first retaining portion. According to this configuration, since the first straight portion made of metal comes into surface contact with the first retaining portion made of synthetic resin, the first locking portion hardly bites into the first retaining portion and the reliability of a retaining function by the first locking portion and the first retaining portion is excellent.
(6) Preferably, a width in a circumferential direction of the first air chamber is larger than an outer diameter of the first inner conductor. According to this configuration, a sufficiently large volume of the first air chamber can be ensured.
(7) Preferably, a front end part of the first inner conductor is formed with a first connecting portion to be connected to the second inner conductor while being accommodated in the first dielectric, and a front end of the first air chamber is shaped to be open only in the peripheral surface of the first dielectric without being open in a front end surface of the first dielectric. According to this configuration, if the first inner conductor is inclined into an oblique posture, that inclination is suppressed by the contact of the first inner conductor with the inner peripheral surface of the first dielectric. Since the first air chamber is not open in the front end surface of the first dielectric, the first dielectric is high in rigidity. In this way, the posture inclination of the first inner conductor can be reliably suppressed by the rigidity of the first dielectric.
(8) Preferably, a front end surface of the first dielectric is formed with a tapered guiding surface for guiding the second inner conductor into the first dielectric, and a front end of the first air chamber is shaped to be open only in the peripheral surface of the first dielectric without being open in the front end surface of the first dielectric. According to this configuration, since the dielectric can be shaped to be seamlessly continuous over an entire periphery, the reliability of a guiding function by the guiding surface is excellent.
(9) Preferably, the second air chamber is open in an inner peripheral surface of the second dielectric, the second inner conductor is inserted into the second dielectric from behind, the second inner conductor is formed with a second locking portion, and the second inner conductor is retained by locking the second locking portion to a second retaining portion on an opening edge part of the second air chamber. According to this configuration, since the second air chamber has both a function of enhancing impedance matching and a function of retaining the second inner conductor, the shape of the second dielectric can be simplified.
(10) Preferably, in (9), the second locking portion is resiliently deformed in the radial direction in the process of inserting the second inner conductor into the second dielectric, and the second locking portion resiliently returns and is locked to the second retaining portion when the second inner conductor is inserted to a proper position with respect to the second dielectric. According to this configuration, insertion resistance can be reduced in the process of inserting the second inner conductor into the second dielectric. When the second inner conductor is inserted to the proper position, a click feeling due to a resilient returning movement of the second locking portion can be sensed.
(11) Preferably, in (9) or (10), the second locking portion includes a second tapered portion extending obliquely rearward from an outer peripheral surface of the second inner conductor, and a second straight portion cantilevered parallel to an axis of the second inner conductor from a rear end of the second tapered surface. According to this configuration, since a radial projection dimension of the second locking portion is suppressed to be small, an outer diameter variation in the second inner conductor is reduced and impedance matching is enhanced.
(12) Preferably, in (11), the second inner conductor is retained by a rear end surface of the second straight portion coming into surface contact with the second retaining portion. According to this configuration, since the second straight portion made of metal comes into surface contact with the second retaining portion made of synthetic resin, the second locking portion hardly bites into the second retaining portion and the reliability of a retaining function by the second locking portion and the second retaining portion is excellent.

### Details of Embodiment of Present Disclosure

### Embodiment

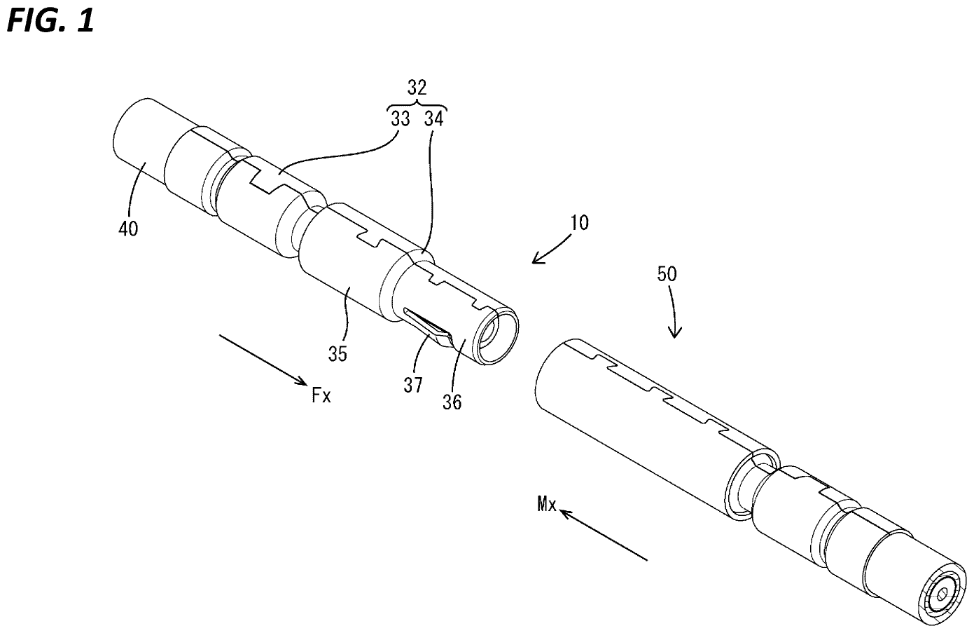

A shield connector of a specific embodiment of the present disclosure is described below with reference to FIGS. 1 to 9. Note that the present invention is not limited to these illustrations, but is represented by claims and intended to include all changes in the scope of claims and in the meaning and scope of equivalents. The shield connector of this embodiment is provided with a first connector 10 and a second connector 50 connectable to and separable from each other (see FIG. 1).

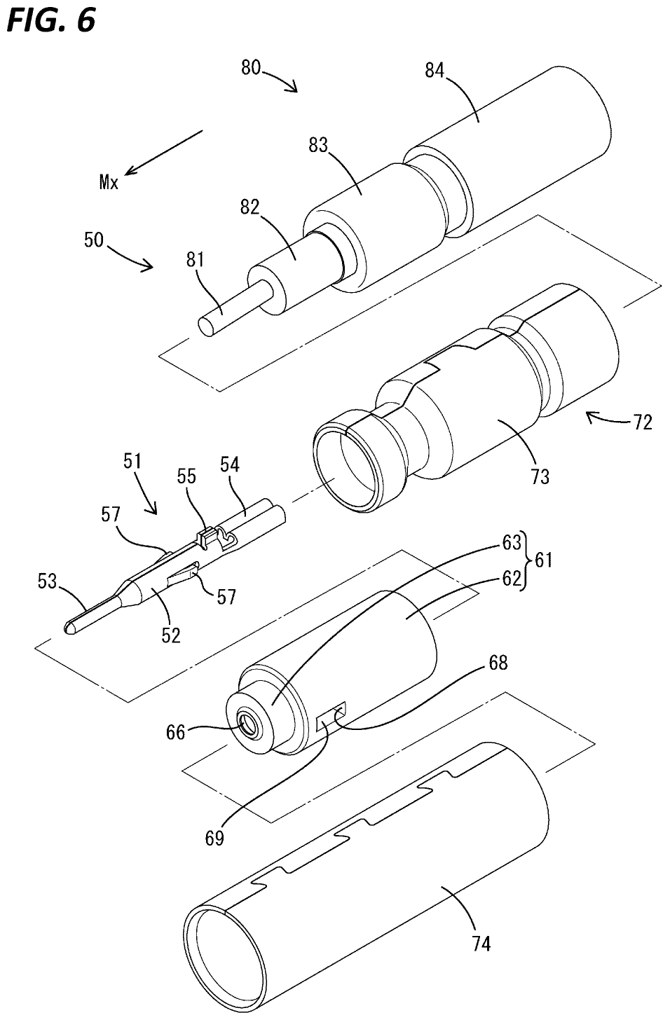

An Fx direction in FIGS. 1 to 5 and 9 is defined as a forward direction concerning a front-rear direction of the first connector 10. An Mx direction in FIGS. 6 to 9 is defined as a forward direction concerning a front-rear direction of the second connector 50. The front-rear directions of the first and second connectors 10, 50 are exact opposite directions. Axial directions of the first and second connectors 10, 50 are used as synonyms of the front-rear directions.

### First Connector 10

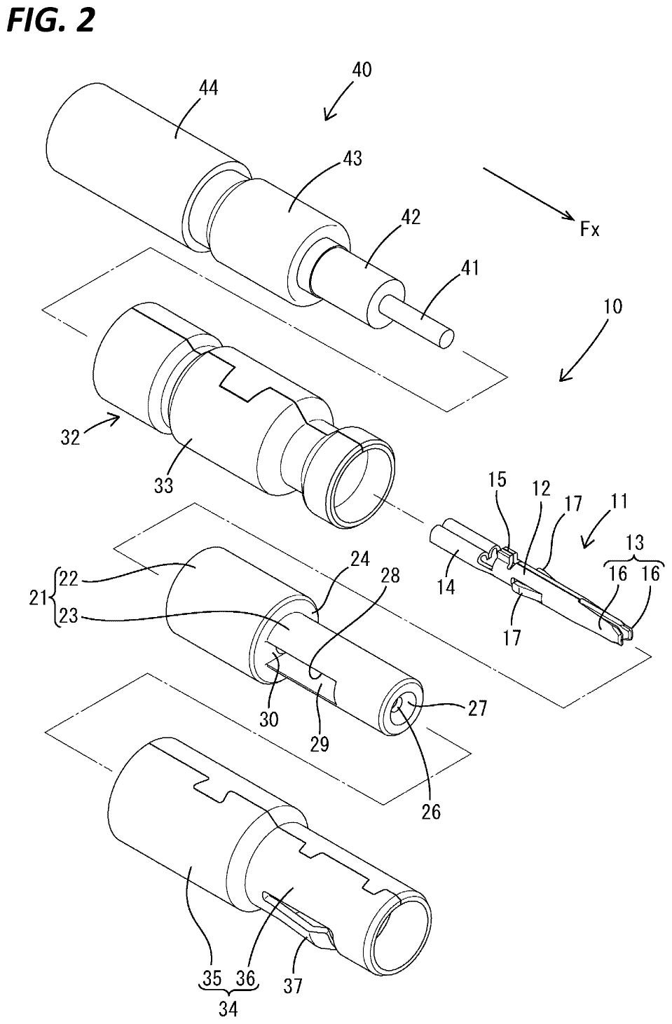

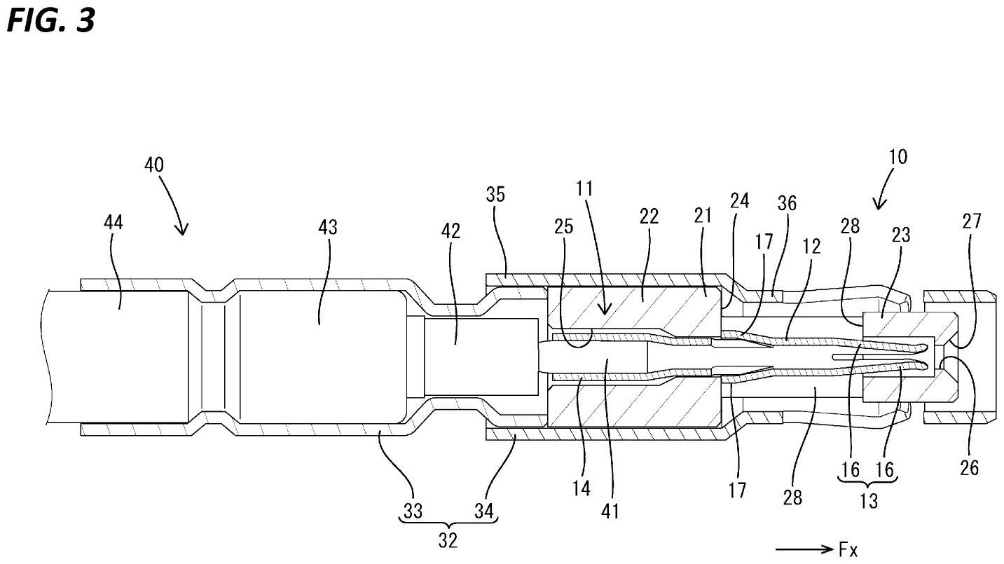

The first connector 10 is a member having a shielding function and fixed to a front end part of a first shielded cable 40. As shown in FIGS. 2 and 3, the first shielded cable 40 is such a coaxial cable that one first core wire 41 is surrounded by a first insulation coating 42, the first insulation coating 42 is surrounded by a first shield layer 43 constituted by a braided wire or the like, and the first shield layer 43 is surrounded by a first sheath 44. The first connector 10 has a cylindrical shape elongated in the front-rear direction as a whole. As shown in FIGS. 2 and 3, the first connector 10 is configured by concentrically assembling one first inner conductor 11, one first dielectric 21 surrounding the first inner conductor 11 and a first outer conductor 32 surrounding the first dielectric 21.

As shown in FIG. 2, the first inner conductor 11 is a single component including a first body portion 12 having a hollow cylindrical shape, a first connecting portion 13 and a first crimping portion 14. The first body portion 12 is formed with a first stabilizer 15 projecting radially outward from the outer peripheral surface of the first body portion 12. The first connecting portion 13 is cantilevered forward from the front end of the first body portion 12 and has a shape tapered toward the front as a whole. As shown in FIG. 3, the first connecting portion 13 includes a pair of radially divided connection spring pieces 16. The first crimping portion 14 is a part in the form of an open barrel cantilevered rearward from the rear end of the first body portion 12. The first crimping portion 14 is conductively crimped to the first core wire 41 of the first shielded cable 40.

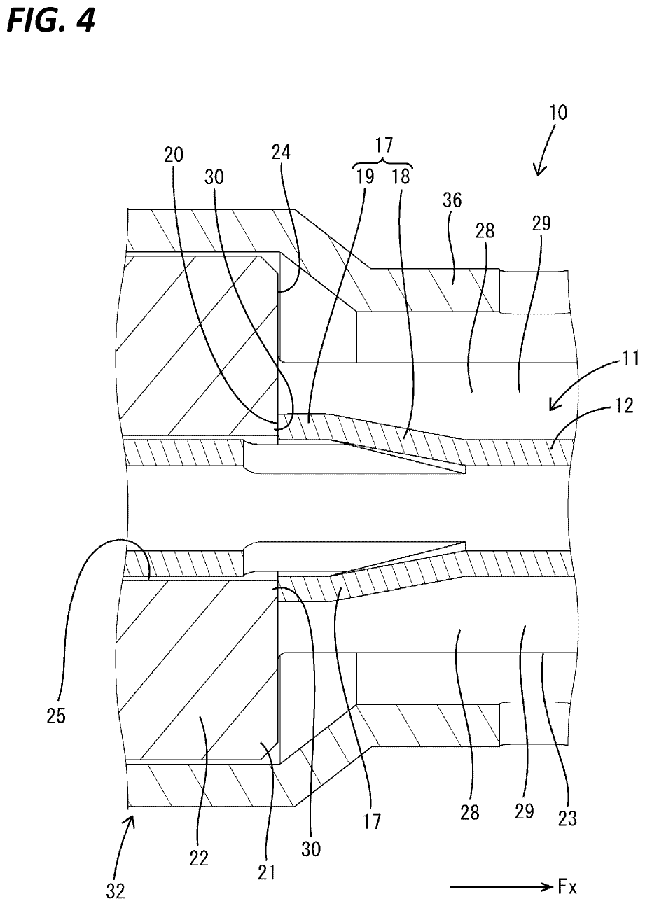

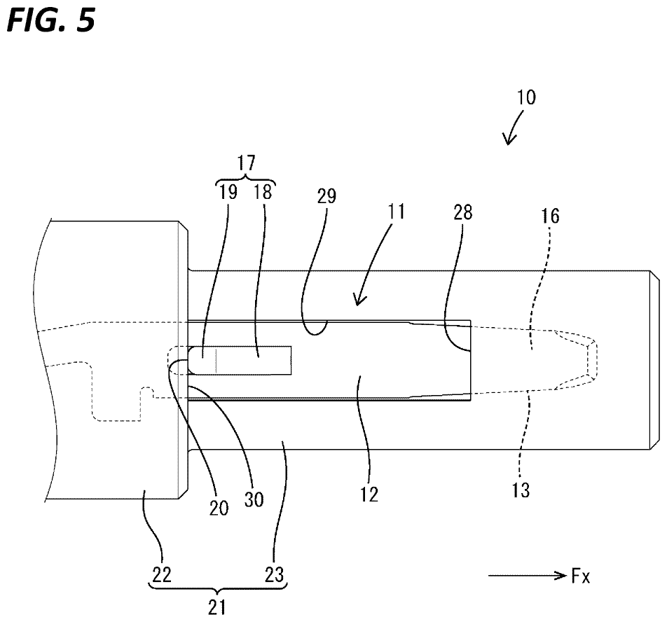

The first body portion 12 is formed with a pair of first locking portions 17 shaped to be point-symmetrical about a center axis of the first body portion 12. The first locking portion 17 is arranged radially outward of the outer peripheral surface of the first body portion 12 and cantilevered rearward as a whole. As shown in FIGS. 4 and 5, the first locking portion 17 includes a first tapered portion 18 and a first straight portion 19. The first tapered portion 18 is a part extending obliquely rearward from the outer peripheral surface of the first body portion 12. The first straight portion 19 is a part extending rearward in parallel to an axis of the first inner conductor 11 from the rear end of the first tapered portion 18. The projecting end surface of the first straight portion 19 has a function as a first locking surface 20 formed by a flat surface orthogonal to the axis of the first inner conductor 11. The first locking portion 17 can be resiliently displaced in a radial direction with a front end part of the first locking portion 17 as a fulcrum.

The first dielectric 21 is made of a synthetic resin material and has a cylindrical shape elongated in the front-rear direction. As shown in FIG. 2, the first dielectric 21 is a single component including a first large-diameter portion 22 and a first small-diameter portion 23 having a smaller diameter than the first large-diameter portion 22. The first small-diameter portion 23 concentrically projects forward from the front end of the first large-diameter portion 22. A dimension in the front-rear direction of the first large-diameter portion 22 is larger than that of the small-diameter portion 23. A deflection allowance space 24 surrounding the first small-diameter portion 23 is formed on the outer peripheral surface of the first dielectric 21 by a difference in outer diameter between the first large-diameter portion 22 and the first small-diameter portion 23.

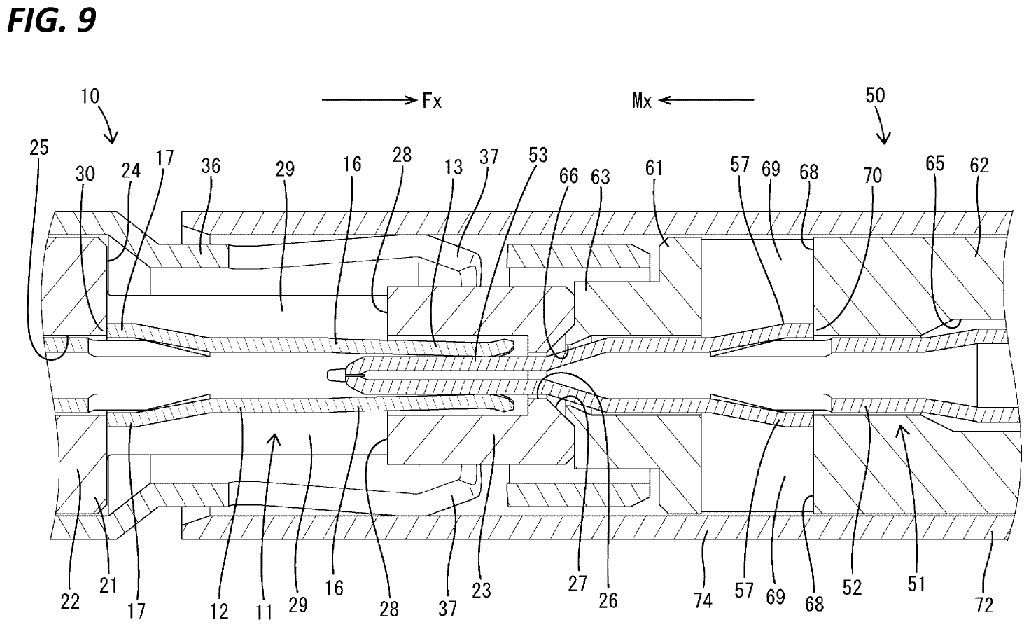

As shown in FIGS. 3 and 4, a first accommodation chamber 25 open in both front and rear end surfaces of the first dielectric 21 is formed inside the first dielectric 21. As shown in FIG. 9, a front end part of the first dielectric 21 is formed with an insertion hole 26 for inserting a second connecting portion 53 of a second inner conductor 51 into the first accommodation chamber 25. A tapered guiding surface 27 for guiding the second connecting portion 53 into the insertion hole 26 is formed over the entire circumference of the insertion hole 26 on the front end surface of the first dielectric 21. The first large-diameter portion 22 is formed with a first rotation stop portion (not shown) shaped by recessing the inner peripheral surface of the first accommodation chamber 25.

As shown in FIGS. 3, 4 and 9, the first small-diameter portion 23 is formed with a pair of first cut portions 28. The pair of first cut portions 28 are shaped to be point-symmetrical about a center axis of the first dielectric 21 (first small-diameter portion 23). An internal space of the first cut portion 28 functions as a first air chamber 29 for enhancing impedance matching. The first cut portion 28 is open in the inner and outer peripheral surfaces of the first accommodation chamber 25 and radially penetrates through the first small-diameter portion 23. Opening shapes of the first cut portion 28 in the outer and inner peripheral surfaces of the first small-diameter portion 23 are rectangular shapes having long sides oriented in an axial direction of the first small-diameter portion 23. A width in a circumferential direction of the first cut portion 28 when the first small-diameter portion 23 is viewed in a radial direction is slightly larger than a diameter of the first body portion 12 of the first inner conductor 11. Since the width in the circumferential direction of the first cut portion 28 (first air chamber 29) is larger than the outer diameter of the first body portion 12 of the first inner conductor 11, a sufficiently large volume of the first air chamber 29 can be ensured.

The front end of the first cut portion 28 is located behind the front end of the first dielectric 21 (first small-diameter portion 23). The first cut portion 28 is not open in the front end surface of the first dielectric 21. The rear end of the first cut portion 28 is located at the same position as the rear end of the first small-diameter portion 23 (front end of the first large-diameter portion 22) in the front-rear direction. A rear end part of an opening edge part of the first cut portion 28 in the inner peripheral surface of the first dielectric 21 functions as a first retaining portion 30. The first retaining portion 30 is formed by a flat surface orthogonal to the axis of the first dielectric 21.

The first inner conductor 11 is concentrically inserted into the first accommodation chamber 25 from behind the first dielectric 21. In the process of inserting the first inner conductor 11, the first locking portions 17 are resiliently deformed by interfering with the inner peripheral surface of the first accommodation chamber 25. When the first inner conductor 11 reaches a proper insertion position, the first locking portions 17 resiliently return radially outward and the first locking surfaces 20 of the first locking portions 17 are locked in surface contact with the first retaining portions 30 from front. By this locking action, the first inner conductor 11 is held retained with a rearward movement with respect to the first dielectric 21 restricted. The first locking portions 17 are accommodated in the first cut portions 28. The first stabilizer 15 is fit into the first rotation stop portion (not shown), whereby the first inner conductor 11 is held positioned with rotation with respect to the first dielectric 21 restricted. The front ends of the first cut portions 28 are located behind the front end of the first connecting portion 13.

As shown in FIGS. 2 and 3, the first outer conductor 32 is configured by uniting a first rear outer conductor 33 having a hollow cylindrical shape and a first front outer conductor 34 having a hollow cylindrical shape as a whole. The first rear outer conductor 33 surrounds a front end part of the first shielded cable 40 and is conductively fixed to the first shield layer 43. A rear end part of the first front outer conductor 34 is conductively fixed to the first rear outer conductor 33. The first front outer conductor 34 concentrically surrounds the entire first inner conductor 11 and the entire first dielectric 21.

The first front outer conductor 34 includes a large-diameter tube portion 35 having a hollow cylindrical shape and a small-diameter tube portion 36 having a smaller diameter than the large-diameter tube portion 35. The small-diameter tube portion 36 has a hollow cylindrical shape as a whole and concentrically extends forward from the front end of the large-diameter tube portion 35. The small-diameter tube portion 36 is formed with a plurality of (three) resilient contact pieces 37 spaced apart in the circumferential direction. The large-diameter tube portion 35 surrounds the first large-diameter portion 22 of the first dielectric 21. The small-diameter tube portion 36 surrounds the first small-diameter portion 23. The resilient contact pieces 37 are accommodated in the deflection allowance space 24. The resilient contact pieces 37 can be resiliently displaced in the radial direction in the deflection allowance space 24.

### Second Connector 50

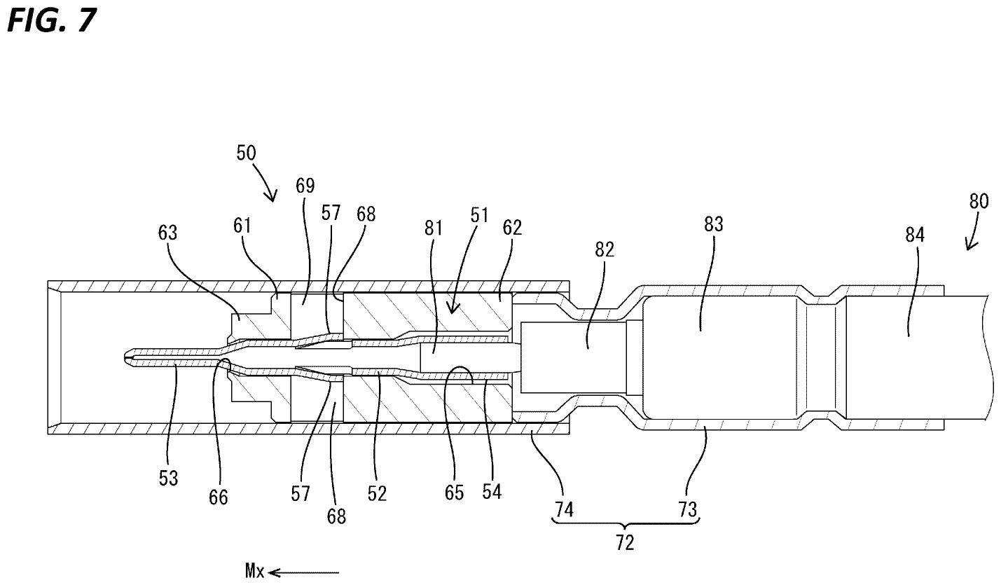

The second connector 50 is a member having a shielding function and fixed to a front end part of a second shielded cable 80. As shown in FIGS. 6 and 7, the second shielded cable 80 is such a coaxial cable that one second core wire 81 is surrounded by a second insulation coating 82, the second insulation coating 82 is surrounded by a second shield layer 83 constituted by a braided wire or the like, and the second shield layer 83 is surrounded by a second sheath 84. The second connector 50 has a cylindrical shape elongated in the front-rear direction as a whole. As shown in FIG. 6, the second connector 50 is configured by concentrically assembling one second inner conductor 51, one second dielectric 61 surrounding the second inner conductor 51 and a second outer conductor 72 surrounding the second dielectric 61.

As shown in FIGS. 6 and 7, the second inner conductor 51 is a single component including a second body portion 52 having a hollow cylindrical shape, the second connecting portion 53 and a second crimping portion 54. An outer diameter of the second body portion 52 is equal to that of the first body portion 12 of the first inner conductor 11. The second body portion 52 is formed with a second stabilizer 55 projecting radially outward from the outer peripheral surface of the second body portion 52. The second connecting portion 53 is cantilevered forward from the front end of the second body portion 52 and has an elongated shape having a smaller diameter than the second body portion 52. The second crimping portion 54 is a part in the form of an open barrel cantilevered rearward from the rear end of the second body portion 52. The second crimping portion 54 is conductively crimped to the second core wire 81 of the second shielded cable 80.

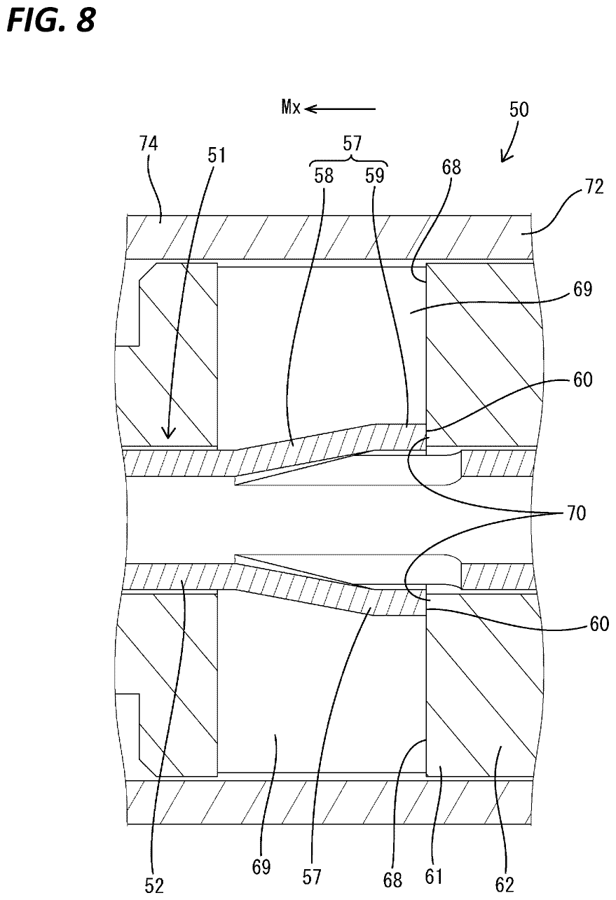

The second body portion 52 is formed with a pair of second locking portions 57 shaped to be point-symmetrical about a center axis of the second body portion 52. The second locking portion 57 is arranged radially outward of the outer peripheral surface of the second body portion 52 and cantilevered rearward as a whole. As shown in FIG. 8, the second locking portion 57 includes a second tapered portion 58 and a second straight portion 59. The second tapered portion 58 is a part extending obliquely rearward from the outer peripheral surface of the second body portion 52. The second straight portion 59 is a part extending rearward in parallel to an axis of the second inner conductor 51 from the rear end of the second tapered portion 58. The projecting end surface of the second straight portion 59 has a function as a second locking surface 60 formed by a flat surface orthogonal to the axis of the second inner conductor 51. The second locking portion 57 can be resiliently displaced in a radial direction with a front end part of the first locking portion 17 as a fulcrum.

The second dielectric 61 is made of a synthetic resin material and has a cylindrical shape elongated in the front-rear direction. As shown in FIGS. 6 and 7, the second dielectric 61 is a single component including a second large-diameter portion 62 and a second small-diameter portion 63 having a smaller diameter than the second large-diameter portion 62. The second small-diameter portion 63 concentrically projects forward from the front end of the second large-diameter portion 62. A dimension in the front-rear direction of the second large-diameter portion 62 is larger than that of the small-diameter portion 63. A second accommodation chamber 65 open in both front and rear end surfaces of the second dielectric 61 is formed inside the second dielectric 61. A front end part of the second dielectric 61 is formed with an opening 66 for allowing the second connecting portion 53 to project forward of the second dielectric 61. The second large-diameter portion 62 is formed with a second rotation stop portion (not shown) shaped by recessing the inner peripheral surface of the second accommodation chamber 65.

As shown in FIGS. 6, 8 and 9, the second large-diameter portion 62 is formed with a pair of second cut portions 68. The pair of cut portions are shaped to be point-symmetrical about a center axis of the second dielectric 61 (second large-diameter portion 62). An internal space of the second cut portion 68 functions as a second air chamber 69 for enhancing impedance matching. The second cut portion 68 is open in the inner and outer peripheral surfaces of the second accommodation chamber 65 and radially penetrates through the second large-diameter portion 62. Opening shapes of the second cut portion 68 in the outer and inner peripheral surfaces of the second large-diameter portion 62 are rectangular shapes having long sides oriented in an axial direction of the second large-diameter portion 62. A width in a circumferential direction of the second cut portion 68 when the second large-diameter portion 62 is viewed in a radial direction is slightly smaller than a diameter of the second body portion 52 of the second inner conductor 51.

The front end of the second cut portion 68 is located behind the front end of the second dielectric 61 (second large-diameter portion 62). The second cut portion 68 is not open in the front end surface of the second dielectric 61. The front end of the second cut portion 68 is located behind the front end of the second large-diameter portion 62 (rear end of the second small-diameter portion 63) in the front-rear direction. A rear end part of an opening edge part of the second cut portion 68 in the inner peripheral surface of the second dielectric 61 functions as a second retaining portion 70. The second retaining portion 70 is formed by a flat surface orthogonal to the axis of the second dielectric 61.

The second inner conductor 51 is concentrically inserted into the second accommodation chamber 65 from behind the second dielectric 61. In the process of inserting the second inner conductor 51, the second locking portions 57 are resiliently deformed by interfering with the inner peripheral surface of the second accommodation chamber 65. When the second inner conductor 51 reaches a proper insertion position, the second locking portions 57 resiliently return radially outward and the second locking surfaces 60 of the second locking portions 57 are locked in surface contact with the second retaining portions 70 from front. By this locking action, the second inner conductor 51 is held retained with a rearward movement with respect to the second dielectric 61 restricted. The second locking portions 57 are accommodated in the second cut portions 68. The second stabilizer 55 is fit into the second rotation stop portion (not shown), whereby the second inner conductor 51 is held positioned with rotation with respect to the second dielectric 61 restricted.

As shown in FIGS. 6 and 7, the second outer conductor 72 is configured by uniting a second rear outer conductor 73 having a hollow cylindrical shape and a second front outer conductor 74 having a hollow cylindrical shape. The second rear outer conductor 73 surrounds a front end part of the second shielded cable 80 and is conductively fixed to the second shield layer 83. A rear end part of the second front outer conductor 74 is conductively fixed to the second rear outer conductor 73. The second front outer conductor 74 concentrically surrounds the entire second inner conductor 51 and the entire second dielectric 61.

### Functions and Effects of Embodiment

The first and second connectors 10, 50 are connected to butt the front end parts thereof against each other. With the both connectors 10, 50 connected, the second connecting portion 53 of the second inner conductor 51 enters to be interposed between the pair of connection spring pieces 16 of the first inner conductor 11 as shown in FIG. 9 and the first and second inner conductors 11, 51 are conductively connected. The resilient contact pieces 37 of the first front outer conductor 34 resiliently contact the inner peripheral surface of the second front outer conductor 74, and the first and second outer conductors 32, 72 are conductively connected.

An outer diameter of the second front outer conductor 74 is equal to that of the large-diameter tube portion 35 of the first front outer conductor 34 and larger than that of the small-diameter tube portion 36. An inner diameter of the second front outer conductor 74 is equal to that of the large-diameter tube portion 35 and larger than that of the small-diameter tube portion 36. An interval in the radial direction between the first body portion 12 of the first inner conductor 11 and the small-diameter tube portion 36 of the first outer conductor 32 is narrower than an interval in the radial direction between the second body portion 52 of the second inner conductor 51 and the second front outer conductor 74. The outer diameter of the first body portion 12 and that of the second body portion 52 are equal. A radial thickness of the first small-diameter portion 23 surrounding the first body portion 12, out of the first dielectric 21, is smaller than that of the second large-diameter portion 62 surrounding the second body portion 52, out of the second dielectric 61. Thus, there is a concern that an impedance in a formation region of the first small-diameter portion 23 and the small-diameter tube portion 36 in the first connector 10 becomes smaller than an impedance in a formation region of the second body portion 52 in the second connector 50.

As a countermeasure against this, in this embodiment, the first small-diameter portion 23 made of synthetic resin is formed with the first cut portions 28 and the second large-diameter portion 62 made of synthetic resin is formed with the second cut portions 68. The width in the circumferential direction of the first cut portion 28 is set to be larger than that of the second cut portion 68, and the length in the axial direction of the first cut portion 28 is set to be larger than that of the second cut portion 68. In this way, even if the first small-diameter portion 23 is thinner than the second large-diameter portion 62, a volume of the first air chamber 29 formed in the first cut portion 28 can be set to be larger than that of the second air chamber 69 formed in the second cut portion 68. Since a characteristic impedance of air is larger than that of synthetic resin, it is realized to enhance the matching of an impedance in the formation region of the first small-diameter portion 23 and the small-diameter tube portion 36 in the first connector 10 and an impedance in the formation region of the second body portion 52 in the second connector 50.

The shield connector of this embodiment is provided with the first and second connectors 10, 50 to be connected to each other. The first connector 10 includes the first inner conductor 11, the first dielectric 21 surrounding the first inner conductor 11 and the first outer conductor 32 surrounding the first dielectric 21. The second connector 50 includes the second inner conductor 51 to be connected to the first inner conductor 11, the second dielectric 61 surrounding the second inner conductor 51 and the second outer conductor 72 to be connected to the first outer conductor 32 while surrounding the second dielectric 61.

The interval in the radial direction between the first body portion 12 of the first inner conductor 11 and the small-diameter tube portion 36 of the first outer conductor 32 is narrower than that between the second body portion 52 of the second inner conductor 51 and the second front outer conductor 74 of the second outer conductor 72. Thus, the characteristic impedance in the region formed with the small-diameter tube portion 36 in the first connector 10 is smaller than that in the region formed with the second body portion 52 in the second connector 50. As a means for reducing this impedance mismatch, the first small-diameter portion 23 of the first dielectric 21 is formed with the first air chambers 29 for impedance matching and the second dielectric 61 is formed with the second air chambers 69 for impedance matching. The first air chamber 29 is a space shaped by recessing the inner and outer peripheral surfaces of the first small-diameter portion 23 and penetrating through the first small-diameter portion 23 in the radial direction. The second air chamber 69 is a space shaped by recessing the inner and outer peripheral surfaces of the second large-diameter portion 62 and penetrating through the second large-diameter portion 62 in the radial direction.

The first air chamber 29 is arranged between the first body portion 12 of the first inner conductor 11 and the small-diameter tube portion 36 of the first front outer conductor 34. The second air chamber 69 is arranged between the second body portion 52 of the second inner conductor 51 and the second front outer conductor 74 of the second dielectric 72. The volume of the first air chamber 29 is set to be larger than that of the second air chamber 69. By this configuration, impedance matching between the first and second connectors 10, 50 can be enhanced.

The first air chamber 29 (first cut portion 28) is open in the inner peripheral surface of the first dielectric 21. The first retaining portion 30 is formed on the opening edge part of the first air chamber 29. The first inner conductor 11 is inserted into the first dielectric 21 from behind. The first inner conductor 11 is formed with the first locking portions 17. The first inner conductor 11 is retained by locking the first locking portions 17 to the first retaining portions 30. Since the first air chamber 29 has both a function of enhancing impedance matching and a function of retaining the first inner conductor 11, the shape of the first dielectric 21 can be simplified.

The second air chamber 69 (second cut portion 68) is open in the inner peripheral surface of the second dielectric 61. The second retaining portion 70 is formed on the opening edge part of the second air chamber 69. The second inner conductor 51 is inserted into the second dielectric 61 from behind. The second inner conductor 51 is formed with the second locking portions 57. The second inner conductor 51 is retained by locking the second locking portions 57 to the second retaining portions 70. Since the second air chamber 69 has both a function of enhancing impedance matching and a function of retaining the second inner conductor 51, the shape of the second dielectric 61 can be simplified.

The first locking portions 17 are resiliently deformed in the radial direction in the process of inserting the first inner conductor 11 into the first dielectric 21. When the first inner conductor 11 is inserted to a proper position with respect to the first dielectric 21, the first locking portions 17 resiliently return and are locked to the first retaining portions 30. According to this configuration, insertion resistance can be reduced in the process of inserting the first inner conductor 11 into the first dielectric 21. When the first inner conductor 11 is inserted to the proper position, a click feeling due to resilient returning movements of the first locking portions 17 can be sensed.

The first locking portion 17 includes the first tapered portion 18 extending obliquely rearward from the outer peripheral surface of the first inner conductor 11 and the first straight portion 19 cantilevered parallel to the axis of the first inner conductor 11 from the rear end of the first tapered surface. According to this configuration, since a radial projection dimension of the first locking portion 17 is suppressed to be small, an outer diameter variation in the first inner conductor 11 is reduced and impedance matching is enhanced.

The rear end surfaces (first locking surfaces 20) of the first straight portions 19 come into surface contact with the first retaining portions 30, whereby the first inner conductor 11 is retained. According to this configuration, since the first straight portion 19 made of metal comes into surface contact with the first retaining portion 30 made of synthetic resin, the first locking portion 17 hardly bites into the first retaining portion 30 and the reliability of a retaining function by the first locking portion 17 and the first retaining portion 30 is excellent.

The second locking portions 57 are resiliently deformed in the radial direction in the process of inserting the second inner conductor 51 into the first dielectric 21. When the second inner conductor 51 is inserted to the proper position with respect to the second dielectric 61, the second locking portions 57 resiliently return and are locked to the second retaining portions 70. According to this configuration, insertion resistance can be reduced in the process of inserting the second inner conductor 51 into the second dielectric 61. When the second inner conductor 51 is inserted to the proper position, a click feeling due to resilient returning movements of the second locking portions 57 can be sensed.

The second locking portion 57 includes the second tapered portion 58 extending obliquely rearward from the outer peripheral surface of the second inner conductor 51 and the second straight portion 59 cantilevered parallel to the axis of the second inner conductor 51 from the rear end of the second tapered surface. According to this configuration, since a radial projection dimension of the second locking portion 57 is suppressed to be small, an outer diameter variation in the second inner conductor 51 is reduced and impedance matching is enhanced.

The rear end surfaces (second locking surfaces 60) of the second straight portions 59 come into surface contact with the second retaining portions 70, whereby the second inner conductor 51 is retained. According to this configuration, since the second straight portion 59 made of metal comes into surface contact with the second retaining portion 70 made of synthetic resin, the second locking portion 57 hardly bites into the second retaining portion 70 and the reliability of a retaining function by the second locking portion 57 and the second retaining portion 70 is excellent.

The front end of the first air chamber 29 (first cut portion 28) is shaped to be open only in the peripheral surfaces (inner and outer peripheral surfaces) of the first dielectric 21 without being open in the front end surface of the first dielectric 21. The front end surface of the first dielectric 21 is formed with the tapered guiding surface 27 for guiding the second connecting portion 53 of the second dielectric 51 into the first dielectric 21. Since the front end of the first air chamber 29 is not open in the front end surface of the first dielectric 21, the first dielectric 21 can be shaped to be seamlessly continuous over an entire periphery. Therefore, the reliability of a guiding function by the guiding surface 27 is excellent.

The front end part of the first inner conductor 11 is formed with the first connecting portion 13. The first connecting portion 13 is connected to the second connecting portion 53 of the second inner conductor 51 while being accommodated into the first dielectric 21. According to this configuration, if the first dielectric 11 is inclined into an oblique posture, that inclination is suppressed by the contact of the first inner conductor 11 with the inner peripheral surface of the first dielectric 21. Since the first air chambers 29 are not open in the front end surface of the first dielectric 21, the first dielectric 21 is high in rigidity. In this way, the posture inclination of the first inner conductor 11 can be reliably suppressed by the rigidity of the first dielectric 21.

### Other Embodiments

The present invention is not limited to the above described and illustrated embodiment, but is represented by claims. The present invention includes all changes in the scope of claims and in the meaning and scope of equivalents and also includes the following embodiments.

The first inner conductor may be a male inner conductor including a tab, and the second inner conductor may be a female inner conductor, into which the tab is inserted.

The first retaining portion may be formed in a part other than the opening edge part of the first air chamber.

The first locking portion may not be resiliently deformed.

The first locking portion may be shaped to extend obliquely rearward over an entire length without including the first straight portion.

The first air chamber may be a space open only in the inner peripheral surface of the first dielectric or may be a space open only in the outer peripheral surface of the first dielectric.

The width in the circumferential direction of the first air chamber may be smaller than or equal to the outer diameter of the first inner conductor.

The first air chamber may be open in the front end surface of the first dielectric.

The second retaining portion may be formed in a part other than the opening edge part of the second air chamber.

The second locking portion may not be resiliently deformed.

The second locking portion may be shaped to extend obliquely rearward over an entire length without including the second straight portion.

The second air chamber may be a space open only in the inner peripheral surface of the second dielectric or may be a space open only in the outer peripheral surface of the second dielectric.

### LIST OF REFERENCE NUMERALS

10 . . . first connector
11 . . . first inner conductor
12 . . . first body portion
13 . . . first connecting portion
14 . . . first crimping portion
15 . . . first stabilizer
16 . . . connection spring piece
17 . . . first locking portion
18 . . . first tapered portion
19 . . . first straight portion
20 . . . first locking surface
21 . . . first dielectric
22 . . . first large-diameter portion
23 . . . first small-diameter portion
24 . . . deflection allowance space
25 . . . first accommodation chamber
26 . . . insertion hole
27 . . . guiding surface
28 . . . first cut portion
29 . . . first air chamber
30 . . . first retaining portion
32 . . . first outer conductor
33 . . . first rear outer conductor
34 . . . first front outer conductor
35 . . . large-diameter tube portion
36 . . . small-diameter tube portion
37 . . . resilient contact piece
40 . . . first shielded cable
41 . . . first core wire
42 . . . first insulation coating
43 . . . first shield layer
44 . . . first sheath
50 . . . . second connector
51 . . . second inner conductor
52 . . . second body portion
53 . . . second connecting portion
54 . . . second crimping portion
55 . . . second stabilizer
57 . . . second locking portion
58 . . . second tapered portion
59 . . . second straight portion
60 . . . second locking surface
61 . . . second dielectric
62 . . . second large-diameter portion
63 . . . second small-diameter portion
65 . . . second accommodation chamber
66 . . . opening
68 . . . second cut portion
69 . . . second air chamber
70 . . . second retaining portion
72 . . . second outer conductor
73 . . . second rear outer conductor
74 . . . second front outer conductor
80 . . . second shielded cable
81 . . . second core wire
82 . . . second insulation coating
83 . . . second shield layer
84 . . . second sheath

1. A shield connector, comprising a first connector and a second connector to be connected to each other,
the first connector including a first inner conductor, a first dielectric surrounding the first inner conductor and a first outer conductor surrounding the first dielectric,
the second connector including a second inner conductor to be connected to the first inner conductor, a second dielectric surrounding the second inner conductor and a second outer conductor to be connected to the first outer conductor while surrounding the second dielectric,
an interval in a radial direction between the first inner conductor and the first outer conductor being narrower than an interval in the radial direction between the second inner conductor and the second outer conductor,
the first dielectric being formed with a first air chamber for impedance matching shaped by recessing a peripheral surface of the first dielectric,
the second dielectric being formed with a second air chamber for impedance matching shaped by recessing a peripheral surface of the second dielectric, and
a volume of the first air chamber being larger than a volume of the second air chamber.

2. The shield connector of claim 1, wherein:
the first air chamber is open in an inner peripheral surface of the first dielectric,
the first inner conductor is inserted into the first dielectric from behind,
the first inner conductor is formed with a first locking portion, and
the first inner conductor is retained by locking the first locking portion to a first retaining portion on an opening edge part of the first air chamber.

3. The shield connector of claim 2, wherein:
the first locking portion is resiliently deformed in the radial direction in the process of inserting the first inner conductor into the first dielectric, and
the first locking portion resiliently returns and is locked to the first retaining portion when the first inner conductor is inserted to a proper position with respect to the first dielectric.

4. The shield connector of claim 2, wherein the first locking portion includes:
a first tapered portion extending obliquely rearward from an outer peripheral surface of the first inner conductor; and
a first straight portion cantilevered parallel to an axis of the first inner conductor from a rear end of the first tapered portion.

5. The shield connector of claim 4, wherein the first inner conductor is retained by a rear end surface of the first straight portion coming into surface contact with the first retaining portion.

6. The shield connector of claim 1, wherein a width in a circumferential direction of the first air chamber is larger than an outer diameter of the first inner conductor.

7. The shield connector of claim 1, wherein:
a front end part of the first inner conductor is formed with a first connecting portion to be connected to the second inner conductor while being accommodated in the first dielectric, and
a front end of the first air chamber is shaped to be open only in the peripheral surface of the first dielectric without being open in a front end surface of the first dielectric.

8. The shield connector of claim 1, wherein:
a front end surface of the first dielectric is formed with a tapered guiding surface for guiding the second inner conductor into the first dielectric, and
a front end of the first air chamber is shaped to be open only in the peripheral surface of the first dielectric without being open in the front end surface of the first dielectric.

9. The shield connector of claim 1, wherein:
the second air chamber is open in an inner peripheral surface of the second dielectric,
the second inner conductor is inserted into the second dielectric from behind,
the second inner conductor is formed with a second locking portion, and
the second inner conductor is retained by locking the second locking portion to a second retaining portion on an opening edge part of the second air chamber.

10. The shield connector of claim 9, wherein:
the second locking portion is resiliently deformed in the radial direction in the process of inserting the second inner conductor into the second dielectric, and
the second locking portion resiliently returns and is locked to the second retaining portion when the second inner conductor is inserted to a proper position with respect to the second dielectric.

11. The shield connector of claim 9, wherein the second locking portion includes:
a second tapered portion extending obliquely rearward from an outer peripheral surface of the second inner conductor; and
a second straight portion cantilevered parallel to an axis of the second inner conductor from a rear end of the second tapered portion.

12. The shield connector of claim 11, wherein the second inner conductor is retained by a rear end surface of the second straight portion coming into surface contact with the second retaining portion.
